(19) United States
(12) Patent Application Publication
(10) Pub. No.: US 2009/0031713 A1
(43) Pub. Date: Feb. 5, 2009

(54) ANTIFREEZING UREA SOLUTION FOR UREA SCR SYSTEM AND UREA SCR SYSTEM USING THE SAME

(75) Inventor: Kazunori Suzuki, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/181,681

(22) Filed: Jul. 29, 2008

(30) Foreign Application Priority Data
Aug. 2, 2007 (JP) 2007-201723

(51) Int. Cl. F01N 3/20; C09K 5/00; C09K 5/20

(52) U.S. Cl. 60/301; 252/73

(57) ABSTRACT

An antifreezing urea solution is disclosed which is supplied from a urea solution tank to an adding value to be injected to an SCR catalyst disposed in an exhaust passage of an internal combustion engine. The antifreezing urea solution includes a mixed solution composed of a concentrated urea solution with a urea concentration of 30 wt % or more, and an organic solvent of an alcohol family with 1 to 7 carbon atoms having a hydrophilic group, wherein the urea solution and the organic solvent of the alcohol family are mixed at a mixture ratio of 7:1 respectively (in a volume ratio) or more, providing a freezing point of −30° C. or less.

### CROSS REFERENCE TO RELATED APPLICATIONS

This application is related to Japanese Patent Application No. 2007-201723, filed on Aug. 2, 2007, the content of which is hereby incorporated by reference.

### BACKGROUND OF THE INVENTION

1. Field of the Invention

The present invention relates to an antifreezing urea solution for use in a urea Selective Catalyst Reduction SCR system having an SCR catalyst disposed in an exhaust passage of an internal combustion engine.

2. Description of the Related Art

In recent years, there has heretofore been known an exhaust aftertreatment device EAD (urea SCR system) as a technology of minimizing nitrogen oxides (NOx) emitted from a vehicular internal combustion engine. The exhaust aftertreatment device EAD includes an SCR catalyst employing urea. A typical exemplary structure of the urea SCR system is shown in FIG. 6. As shown in FIG. 6, an SCR catalyst 100 is disposed in an exhaust pipe 101 of an engine for selectively reducing NOx with the use of an action of a reducing agent. An adding valve 103 is mounted on the exhaust pipe 101 at an inlet of the SCR catalyst 100 to inject a reducing agent composed of a urea solution. The urea solution, injected to the exhaust pipe 101, is subjected to thermal decomposition in the exhaust pipe 101 to generate ammonia, which decompose with the NOx on the SCR catalyst 100. The exhaust pipe 101 also has oxidizing catalysts 102a and 102b which are placed on both sides of the SCR catalyst 100.

The urea solution, acting as the reducing agent, is stored in a urea solution tank 104 carried on the vehicle. The urea solution tank 104 is connected through a first urea water feed pipe 105a to a pump 106 having a filter 106a to draw the urea solution. The pump 106 delivers the urea solution through a second urea water feed pipe 105b to an adding valve 103, with which the urea solution is injected to the exhaust pipe 101. The urea solution is easier to use than ammonia and is much less toxic to be preferably used for the urea SCR system. It has been a mainstream practice to use a 32.5% water solution with the lowest freezing point (−11 C°). The pump 106 is also connected to the tank 104 through a urea-water recirculation pipe 105c through which the surplus urea solution is circulated thereto.

However, under a circumstance where a usage environment reaches an extremely low temperature in a cold area or at midwinter, there is a possibility of a drop in temperature around the urea-water tank 104 to the freezing point (−11 C°) of the urea solution. Therefore, the urea solution is susceptible to locally freeze or completely freeze in the urea solution tank and, thus, there is a need to take countermeasures for avoiding the freezing under low temperature environments.

To address such an issue, as shown in FIG. 6, an attempt has been made in the related art to have a heater 107a, placed in the urea solution tank 104, which is operated with an ECU 109 depending on a monitored result of a temperature sensor 108. Heaters 107b to 107f are also disposed in the urea water recirculation pipe 105c, the first urea water feed pipe 105a connected to the urea solution tank 104, the second urea water feed pipe 105b, an inside area of the pump 106 and an outside piping area thereof, respectively. Thus, an overall system is susceptible to be complex in structure and control. As shown in FIG. 6, the adding valve 103 is driven with an actuator 110 supplied with compressed air through an air passage 111 incorporating therein an air compressor 111a. Thus, compressed air is delivered to the adding valve 103 to allow the urea solution into the exhaust pipe 101.

In addition, once a localized area was frozen in the tank, an issue was encountered with a risk of instability caused in a concentration of the urea solution to be supplied to the adding valve. This was because if the localized freezing took place, then, the concentration of urea water prevailing around the frozen area and drawn from the pump 106 increases and, thereafter, as urea water was caused to totally unfreeze due to the operation of the heater 107a, urea water had a concentration lower than a preset concentration. In a case where the heater 107a was operated, the tank was susceptible to a temperature irregularity, causing a possibility of a partial area becoming oversaturated with urea being precipitated. Therefore, even if the issue of the freezing is addressed, the urea solution is susceptible to suffer an unevenness in concentration and, thus, a difficulty is encountered in realizing desired NOx purifying performance.

An attempt has been made to further lower the freezing temperature of the reducing agent per se for thereby addressing such an issue set forth above. It has been proposed to use an alcohol solution of urea, lower in freezing point than that of a urea solution, as a reducing agent as disclosed in Japanese Patent Application Publication 2000-213335. In such a proposal, alcohol is also used as a reducing agent. A urea NOx reducing catalyst, acting at a relatively high temperature, is disposed in an upstream side and an alcohol NOx reducing catalyst, acting at a relatively low temperature, is disposed in the downstream side.

However, with a system employing the urea-alcohol reducing agent, disclosed in such Patent Publication, a need arises for separate catalysts to be adopted to suit respective purposes in order to develop a reducing action of urea and alcohol, resulting in a large size of a catalytic system. Further, upon careful studies on NOx reducing performance conducted by the present inventor, it has been turned out that the urea-alcohol reducing agent generates a less amount of ammonia and has a difficulty of expecting to have an adequate effect because of an issue arising with an increase in the amount of deposit production due to resulting side reaction.

### SUMMARY OF THE INVENTION

The present invention has been completed with the above view in mind and has an object to provide an antifreezing urea solution for use in a urea SCR system as a reducing agent with no risk of freezing in an extremely cold area and a urea SCR system having a simplified system structure including an SCR catalyst, mounted on an exhaust pipe, to which ammonia gas is stably supplied for realizing increased NOx purifying performance.

To achieve the above object, one aspect of the present invention provides an antifreezing urea solution for use in a urea SCR system having an SCR catalyst disposed in an exhaust passage of an internal combustion engine for selectively reducing NOx, the antifreezing urea solution comprising a concentrated urea solution with a urea concentration of 30 wt % or more and an organic solvent of an alcohol family with 1 to 7 carbon atoms having a hydrophilic group. The urea solution and the organic solvent of the alcohol family are mixed to each other to form a mixed solution at a mixture ratio of 7:1 respectively (in a volume ratio) or more.

According to the present invention, urea serving as an ammonia source is formed in the mixed solution with urea dissolved in a solvent in which the organic solvent of alcohol family with 1 to 7 carbon atoms and water are coexistent. This makes it possible to facilitate hydrolytic reaction of urea in a liquefied form with an antifreeze effect to generate ammonia while lowering a freezing point.

With a solution in which urea is merely dissolved with the organic solvent of alcohol family, like the related art, alcohol is evaporated before decomposition of urea occurring in the exhaust passage, providing no contribution to the decomposition of urea. Further, the existence of only the organic solvent of alcohol family results in a less affinity in a molecular structure and it is hard to obtain solubility with a degree as high as that in water. Thus, the urea solution has deteriorated utilization efficiency. With the present invention, water is made coexistent as a solvent to increase the solubility of urea, thereby increasing the amount of ammonia due to hydrolytic reaction of urea. When this takes place, mixing the organic solvent to the urea solution with a given high concentration at a given mixing ratio easily results in the preparation of a concentrated urea solution having a freezing point of −30° C. or less.

Therefore, no risk of freezing takes place in the cold area and no need arises to use the heater means or the like. This results in a simplified system structure through which ammonia reducing gas can be supplied to the SCR catalyst in a stable manner, thereby enabling the realization of high NOx purifying performance.

According to the present invention, the mixture ratio of the organic solvent of the alcohol family to the urea solution may be preferably 4:1 (in a volume ratio) or more.

The greater the mixing ratio of the organic solvent of the alcohol family, the lower will be the freezing point. Preferably, in order to avoid the freezing in the extremely cold area, the organic solvent of the alcohol family is added at the given mixing ratio, thereby making it possible to easily prepare the concentrated urea solution having the freezing point of −40° C. or less.

With the present invention, the organic solvent of the alcohol family may be preferably alcohol with 1 to 3 carbon atoms.

Preferably, using alcohol with these number of carbon atoms results in minimizing CO₂ that would occur when alcohol burns on the catalyst. In addition, this can reduce an adverse affect of unburned carbons accumulating on the catalyst.

With the present invention, the urea solution may preferably have a concentration ranging from 32 to 34 wt %.

Preferably, with the urea solution arranged to have a concentration falling in the given range mentioned above, the antifreezing urea solution has the lowest freezing point. In addition, using easily-commercially-available urea solution results in a capability of easily performing the preparation at reduced cost.

According to another aspect of the present invention, there is provided an antifreezing urea solution for use in a urea SCR system having an SCR catalyst disposed in an exhaust passage of an internal combustion engine for selectively reducing NOx. The antifreezing urea solution comprises a mixed solution composed of a urea solution containing urea, serving as an ammonia source, and water which are mixed to each other at a mixing ratio of 1:1 (in a molar ratio) for hydrolyzing urea, and an organic solvent of an alcohol family with 1 to 7 carbon atoms having a hydrophilic group and serving as a freezing point depressant. The urea solution and the organic solvent of the alcohol family are mixed to each other to form the mixed solution with a freezing point of −30° C. or less.

The urea solution, added to the exhaust passage, is decomposed due to heats of exhaust gases and further hydrolyzed, thereby generating ammonia. When this takes place, in order to generate ammonia from concurrently generated cyanic acid, the existence of water is absolutely necessary. With urea and water mixed to each other at a mixing ratio of 1:1 (in molar ratio) or more, ammonia reducing gas can be supplied to the SCR catalyst. Further, with the urea solution prepared in the coexistent with the organic solvent of the alcohol family with 1 to 7 carbon atoms results in a capability of easily preparing the antifreezing urea solution with the freezing point of −30° C. or less.

With the antifreezing urea solution implementing the present invention, the formation of ammonia is facilitated due to hydrolytic reaction of urea. In addition, there is no fear of the freezing in the cold area with no need to use the heater means or the like. This results in a simplified system structure with which ammonia reducing gas can be stably supplied to the SCR catalyst, enabling the realization of increased NOx purifying performance.

According to still another aspect of the present invention, there is provided a urea SCR system using the antifreezing urea solution according to claim 1, the urea SCR system comprising an antifreezing urea solution tank for accommodating therein the antifreezing urea solution, urea adding means disposed in an area upstream of the SCR catalyst, and urea supply passage through which the urea adding means and the antifreezing urea solution tank are connected to each other.

With the urea SCR system of the present invention, the urea adding means injects the antifreezing urea solution, supplied form the antifreezing urea solution tank through the urea feed passage, into the exhaust pipe. This allows ammonia gas to be formed, thereby enabling the SCR catalyst, disposed in an upstream area, to reduce and purify NOx. Thus, no freezing takes place in the tank even at the cold area like Hokkaido, Norway, etc., and the antifreezing urea solution has stable concentration, thereby achieving reduction and purification of NOx at increased efficiency.

With the urea SCR system of the present embodiment, no heating means for heating the solution prevailing in the urea supply passage and the antifreezing urea solution tank is provided.

The antifreezing urea solution, implementing the present invention, has a lowered freezing point with no fear of the freezing. Thus, no need arises to provide the heating means like heaters or the like for precluding the occurrence of the freezing, enabling a system structure to be simplified.

### BRIEF DESCRIPTION OF THE DRAWINGS

FIG. 1 is an overall structure view showing an overall structure of a urea SCR system of one embodiment according to the present invention.

FIG. 2A is a schematic view showing a thermal decomposition characteristic (TG-DTA) of urea powder; FIG. 2B is a view illustrating a urea decomposition reaction; and FIG. 2C is a view illustrating a urea side reaction.

FIG. 3A is view showing a thermal decomposition characteristic (TG-DTA) of a urea solution and FIG. 3B is a view showing the thermal decomposition characteristic (TG-DTA) of urea powder.

FIG. 4A is view showing a thermal decomposition characteristic (TG-DTA) of an antifreezing urea solution according to the present invention and FIG. 4B is a view showing a thermal decomposition characteristic (TG-DTA) of a urea ethanol solution.

FIG. 5A is a view illustrating an esterification reaction of urea and FIG. 5B is a view illustrating a urea-ethanol decomposition reaction.

FIG. 6 is a schematic overall structural view showing a urea SCR system of the related art.

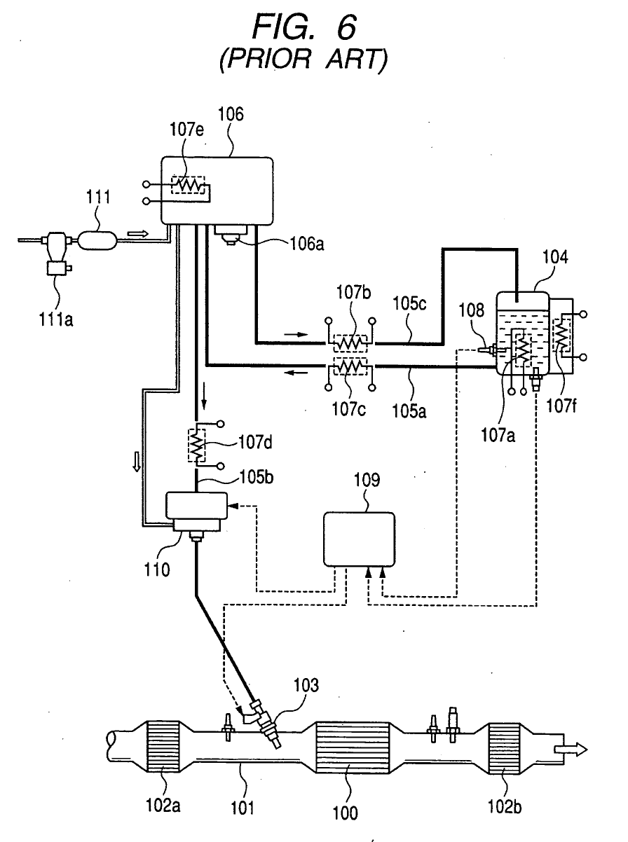

### DETAILED DESCRIPTION OF THE PREFERRED EMBODIMENTS

Now, a urea SCR system for a vehicle internal combustion engine to which the present invention is applied will be described below in detail with reference to the accompanying drawings. However, the present invention is construed not to be limited to such an embodiment described below and technical concepts of the present invention may be implemented in combination with other known technologies or the other technology having functions equivalent to such known technologies.

### Embodiment

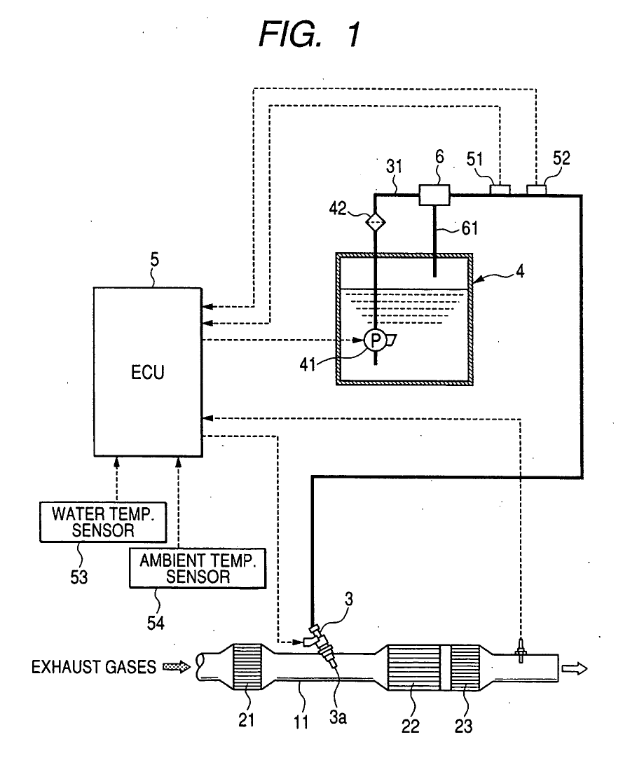

FIG. 1 shows an overall structure of the urea SCR system for the vehicle internal combustion engine to which the present invention is applied. As the internal combustion engine, a multi-cylinder diesel engine is adopted in a structure mounted on a vehicle (not shown). The engine emits exhaust gases which pass through an exhaust-gas aftertreatment device EAD mounted on an exhaust passage 11 to be expelled to the outside of the vehicle.

The exhaust-gas aftertreatment device EAD, mounted on the exhaust passage 11, includes an oxidizing catalyst 21, a selective reduction catalyst (SCR catalyst) 22, serving as a NOx catalyst, and an oxidizing catalyst 23, all of which are placed in sequence from an upstream side. The oxidizing catalyst 21, mounted on the exhaust passage 11 in an area upstream of the SCR catalyst 22, functions to convert nitric oxide (NO) in exhaust gases to nitrogen dioxide (NO₂). This increases an NO₂ ratio in NOx, thereby easily promoting NOx reduction reaction on a subsequent stage. Simultaneously, the oxidizing catalyst 21 also has a function to oxidize hydrocarbon (HC) and carbon monoxide (CO) in exhaust gases.

The SCR catalyst 22 selectively reduces NOx for purification due to an action of a reduction agent. To this end, a reducing agent adding valve 3 is disposed on the exhaust passage 11 in an area between the oxidizing catalyst 21 and the SCR catalyst 22 for supplying a reducing agent to the SCR catalyst 22. With the present invention, urea serving as a precursor of ammonia is employed as the reducing agent in the form of an antifreezing urea solution that is injected through the adding valve 3 into the exhaust gas passage 11. The antifreezing urea solution, implementing the present invention, is a mixed solution composed of urea dissolved in water and alcohol, collectively serving as a solvent, and has a composition whose detail will be described below.

The oxidizing catalyst 23, disposed in a downstream of the SCR catalyst 22, serves to prevent ammonia, resulting from urea, from being discharging to the outside without reacting with NOx. The oxidizing catalyst 23 oxidizes ammonia, leaving the SCR catalyst 22, for decomposition thereof to harmless byproducts. Under a circumstance where an alcohol component acting as the solvent passes from the SCR catalyst 22, the oxidizing catalyst 23 oxidizes alcohol component for decomposition thereof. In the illustrated embodiment, the SCR catalyst 22 and the oxidizing catalyst 23, placed in a downstream thereof, are formed in an integral structure.

The antifreezing urea solution is stored in a urea solution tank 4 for supply to the adding valve 3. The urea solution tank 4 is a sealed vessel, having a given volume, in which a pump 41 is incorporated. Driving the pump 41 allows the urea solution to be drawn through a filter 42 and a urea solution supply passage 31 for delivery to the adding valve 3 under a pressurized state. The adding valve 3 takes the form of, for instance, a known air-assist type injection valve structure. With the air-assist type injection valve, the urea solution supply passage 31 is connected to the adding valve 3 to which an air-feed passage, carrying thereon an air compressor, is connected. The adding valve 3 includes an actuator that is operative to open or close an end nozzle portion 3a to selectively inject the urea solution with assist air to the exhaust passage 11.

As shown in FIG. 1, the adding valve 3 is mounted on a wall of the exhaust passage 11 at a sloped angle. Under such an installed state, the nozzle portion 3a of the adding valve 3 has an injection nozzle exposed to the exhaust passage 11 so as to inject the urea solution in a direction parallel to a flow of exhaust gases passing through the exhaust passage 11. This allows the urea solution to be uniformly supplied to an inlet face end of the SCR catalyst 22 over an entire surface area thereof. A controller unit 5 is connected to the adding valve 3 for controlling a driving state of the same. To this end, the controller unit 5 is applied with detection signals resulting from a pressure sensor 51 and a temperature sensor 52 both of which are mounted on the urea solution supply passage 31, a water temperature sensor 53 and an ambient temperature sensor 54. Further, a pressure regulator 6 is disposed in the urea solution supply passage 31 for regulating a feed pressure of the urea solution to be delivered to the adding valve 3. The pressure regulator 6 is arranged to open the valve when the feed pressure exceeds a preset pressure level to allow an excess of the urea solution to return to the urea solution tank 4 through a return passage 61 connected to an upper portion of the tank 4.

In FIG. 1, when the adding valve 3 is actuated to inject the antifreezing urea solution, implementing the present invention, to the exhaust passage 11, urea contained in the injected urea solution, is subjected to thermal decomposition due to exhaust heat for production of ammonia (NH₃) (see Formula 1). When this takes place, cyanic acid (NHCO), concurrently produced, is further hydrolyzed, thereby producing ammonia and carbon dioxide (see Formula 2). Meanwhile, due to the coexistence with an organic solvent of an alcohol family, urea, contained in the antifreezing urea solution implementing the present invention, is subjected to an esterification reaction with ethanol in the presence of, for instance, ethanol. This results in the production of ammonia and ethyl carbamate (NH₂COOC₂H₅) (see Formula 3). Ethyl carbamate is readily soluble to water and ethanol to form a neutral water solution and generates urea at a temperature of 130° C. Resulting urea is thermally decomposed and hydrolyzed in accordance with the formulae 1 and 2 described below, thereby generating ammonia.

(NH₂)₂CO→NH₃+NHCO (Formula 1)

NHCO+H₂O→NH₃+CO₂ (Formula 2)

(NH₂)₂CO+C₂H₅OH→NH₃+NH₂COOC₂H₅ (Formula 3)

Resulting ammonia serves as a reducing agent of NOx to act on the SCR catalyst 22, thereby promoting a reducing reaction of NOx (see Formula 4). Meanwhile, excess ammonia, which does not contribute to the reduction of NOx and passes from the SCR catalyst 22, is purified with the oxidizing catalyst 23 (Formula 5).

NO+NO₂+2NH₃→2N₂+3H₂O (Formula 4)

4NH₃+3O₂→2N₂+6H₂O (Formula 5)

With the urea SCR system shown in FIG. 1, further, the SCR catalyst 22, disposed downstream of the adding valve 3, and the oxidizing catalyst 23, placed in the subsequent stage, are accommodated in a unitary structure. However, these catalysts 22 and 23 may be separately disposed. In addition, other device structures may be adopted. In an alternative, a system structure may be modified.

The antifreezing urea solution, used as the reducing agent, contains urea, acting as ammonia precursor, water, acting as a solvent, and an organic solvent of an alcohol family. In particular, a mixture solution is prepared by mixing a concentrated urea solution with a urea concentration of 30 wt % or more and the organic solvent of the alcohol family with 1 to 7 carbon atoms having the hydrophilic —OH group. A mixing ratio of the organic solvent of the alcohol family to the urea solution is 7:1 (in volume ratio) or more. This results in an antifreezing urea solution that does not freeze even in a cold area.

Urea acting as an ammonia source is easily dissolved in water acting as the solvent. Thus, preliminarily preparing a urea solution with high concentration containing 30 wt % or more of urea results in an increase in urea-use efficiency. More preferably, the urea solution may have a concentration in the vicinity of 32.5 wt % aqueous solution (with a freezing point of −11° C.) having the lowest freezing temperature. This makes it easy to obtain an effect of lowering the freezing point. Further, it is possible to use a urea solution that is commercially and easily obtainable. If the content of urea exceeds 34 wt %, an uneven temperature variation or an uneven concentration occur in a localized area at low temperatures. Thus, there is a risk of the occurrence of precipitation of a solid urea.

The organic solvent of the alcohol family has the hydrophilic group (—OH) to favorably dissolve urea. Further, the organic solvent of the alcohol family serves as freezing-point depressant in an antifreezing effect. The organic solvent of the alcohol family with 1 to 7 carbon atoms is used because as the carbon atom increases, alcohol is caused to combust on a catalyst with the resultant production of carbon dioxide (CO₂) and remains on the catalyst as unburned carbon in an accumulated state. Preferably, examples of the organic solvent of the alcohol family include methanol (with a freezing point: −94° C.), ethanol (with a freezing point: −114° C.) and isopropyl alcohol (with a freezing point: −90° C.) which have 1 to 3 carbon atoms. These alcohols are general-purpose alcohols and have less specific gravity than that of water with a contribution to the formation of a reducing solution with lightweight. Especially, in recent years, an attempt has been made to study using ethanol solely as automotive fuel or in a mixture with fuel of the related art, making it easy to utilize ethanol for the antifreezing liquid of the present invention.

The ratio of the concentrated urea solution to be mixed to the organic solvent of the alcohol family with 1 to 7 carbon atoms is 7:1 (in volume ratio) or more. In this case, the greater the mixing ratio of the organic solvent of the alcohol family, the further increased effect of lowering the freezing point to avoid the freezing in the cold area. However, as the mixing ratio of the organic solvent of the alcohol family increases, the solubility of urea decreases and alcohol is easily volatile under high temperature environments. Thus, the mixing ratio of the organic solvent of the alcohol family may be preferably determined to have a value that achieves a freezing point required under usage environments.

More particularly, 1) in order to obtain an antifreezing urea solution (100 mL) that does not freeze in a cold area (at −30° C.), the urea solution (32.5 wt %) and ethanol is mixed at a mixing ratio of 87.5 mL:12.5 mL (7:1) (in a volume ratio). To convert this relationship in terms of a weight ratio by referring to the density (1.09) and the concentration (32.5 wt %) of the urea solution, the ratio of urea to water and ethanol can be expressed to be approximately 31g:64g:10g in a ratio of approximately 3:6:1 (in weight ratio) and in a ratio of approximately 29.5:61:9.5 (in wt %).

Further, 2) in order to obtain an antifreezing urea solution (100 mL) that does not freeze in a cold area (at ˜40° C.), the urea solution (32.5 wt %) and ethanol is mixed at a mixing ratio of 80.0 mL:20.0 mL (4:1) (in a volume ratio). To convert this relationship in terms of a weight ratio by referring to the density (1.09) and the concentration (32.5 wt %) of the urea solution, the ratio of urea to water and ethanol can be expressed to be approximately 28g:59g:16g in a ratio of approximately 7:15:4 (in weight ratio) and in a ratio of approximately 27.5:57:15.5 (in wt %).

In using the organic solvent of the alcohol family with the freezing point higher than that of ethanol, or in order to cause the organic solvent of the alcohol family not to freeze even under temperature environments lower than −30° C. or −40° C., a need arises for mixing the organic solvent of the alcohol family to the antifreezing urea solution at a further increasing mixing ratio than the mixing ratio mentioned above. This results in a remarkable drop in the freezing point, thereby realizing the antifreezing urea solution that does not freeze even in the cold area (at −30° C.) or in an extremely cold area (at −40° C.).

The antifreezing urea solution, implementing the present invention, includes the mixed solution employing urea, acting as the ammonia source, and the solvent in which the organic solvent of the alcohol family with 1 to 7 carbon atoms and water are coexistent. This provides not only an antifreezing solution effect but also an effect of accelerating the formation of ammonia due to esterification reaction and hydrolyzing reaction of urea, providing improved NOx purifying performance. Further, using the organic solvent of the alcohol family facilitates evaporating decomposition of the solvent, enabling the reaction at relatively low temperatures. However, using only the organic solvent of the alcohol family results in a difficulty of completely decomposing urea and a need arises to hydrolyze urea in the presence of water. For urea to be hydrolyzed by adding water, urea is mixed to water at a ratio of preferably 1:1 (in molar ratio) and, more preferably, increasing the proportion of water accelerates hydrolysis reaction of urea while suppression a side reaction. This reaction will be described below in mode detail.

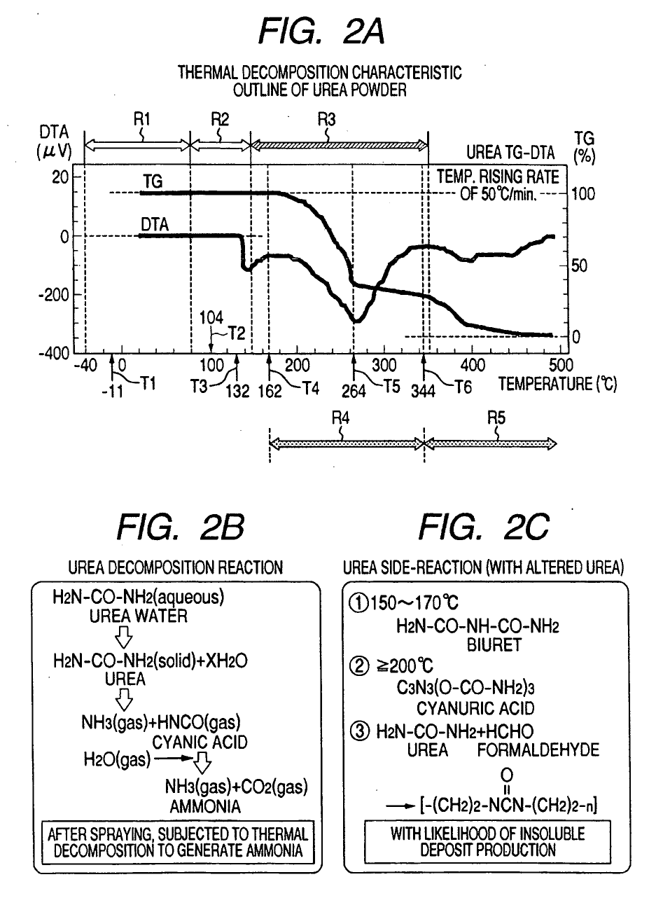

FIG. 2A is a schematic view showing a thermal decomposition characteristic (TG-DTA) of urea powder used as a test piece for evaluation. The test piece was heated under a condition listed below and a variation in weight and endothermic exothermic heats of the evaluation test piece were measured using a differential thermal analyzer. In FIG. 2A, the temperature is plotted on a horizontal axis.

Evaluation Item: TG (on Thermogravimetry) and DTA (on Differential Thermal Analyzer)

Environment: Atmosphere

Evaluation Temperature Range: Ranging from 25° C. to 500° C. (in atmosphere)

Temperature Rising Speed: 50° C./min

Differential Thermal Analyzer: TG-DTA2000SA (manufactured by BRUKER AXS K.K.)

In FIG. 2A, R1 represents a urea-water temperature control range; R2 a reacting region; R3 a urea deposit resulting region; R4 a region in which a high-melting point substance is generated; and R5 a region in which the high-melting point substance is decomposed. T1 represents a urea-water freezing point; T2 a boiling point of urea-water; T3 a melting point of urea; T4 a biuret resulting point; T5 a cyanuric-acid resulting point; and T6 a melamine resulting point.

As will be apparent from FIG. 2A, no ammonia gas is generated merely upon simply heating urea powder. As the temperature of urea powder exceeds the melting point T3 (at 132° C.) of urea, the urea deposit region R3 is established. In such a region, a side reaction urea occurs as shown in FIG. 2C. In this moment, urea alteration takes place, resulting in productions of the high-melting point substances such as biuret, cyanuric acid and urea resin. In order for these high-melting point substances to be decomposed, high temperatures are needed and there is a risk of these substances accumulating on the catalyst as insoluble deposits.

As indicated in FIG. 2A on an upper area of the horizontal axis, meanwhile, the urea solution (with a concentration of 32.5 wt % and a boiling point of 104° C.) has a reacting region falling in a lower temperature region than that of the melting point (132° C.) of urea. With the system of the related art taking the urea solution as the reducing agent, in normal practice, the temperature of urea-water is controlled within a urea-water temperature control range below the boiling point (of 104° C.). Under such a control, the urea solution is sprayed from the adding valve 3 and subsequently heated with heats of exhaust gases to increase in temperature, thereby causing a urea decomposing reaction to take place as shown in FIG. 2B. When this takes place, the urea solution is initially decomposed into urea and water with urea subjected to thermal decomposition to generate ammonia (NH₃) (see Formula 1). In addition, cyanic acid (NHCO), generated with ammonia, is hydrolyzed to generate ammonia and carbon dioxide (see Formula 2).

For the purpose of confirming whether ammonia gas is generated in the presence of water, tests were conducted on the urea solution (with the urea concentration of 32.5 wt %). Ethanol was mixed to the urea solution (with the urea concentration of 32.5 wt %) at a mixture ratio of 1:1 (in volume ratio), thereby preparing the urea solution of the present invention. The thermal decomposition characteristic (TG-DTA) of this solution was measured in the same manner as that mentioned above.

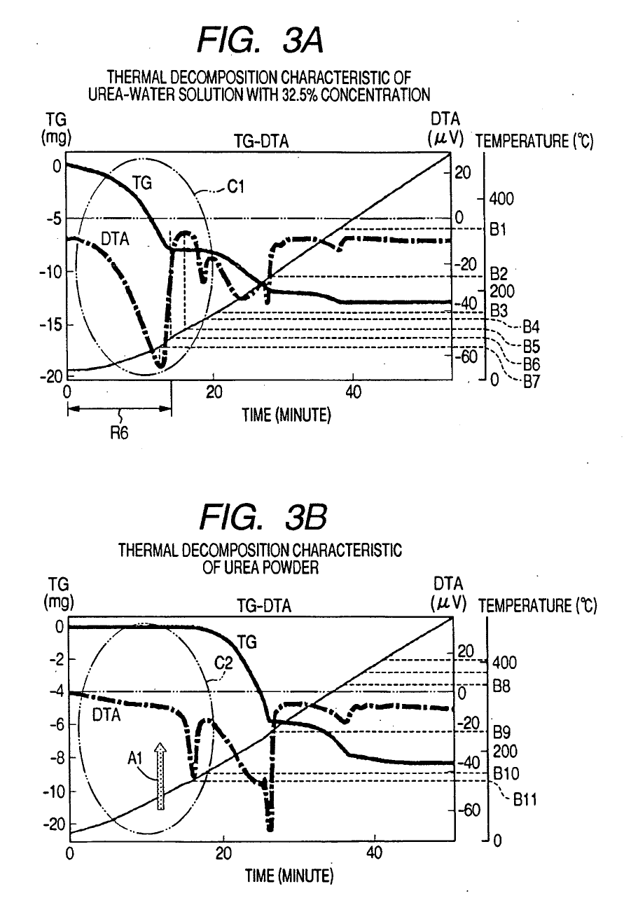

FIG. 3A shows the result of the urea solution in the presence of water with FIG. 3B showing the result with urea powder in the absence of water.

In FIG. 3A, B1 indicates a melanin resulting point; B2 a cyanuric-acid resulting point; B3 a biuret resulting point; B4 urea resulting point (in mp.); B5 a urea-water resulting point (in bp.); B6 a urea-water decomposing point at an (estimated) upper limit temperature; and B7 a urea thermal decomposition point (with generation of ammonia NH₃).

As shown in FIG. 3A, a reaction product with unreacted urea-water occurs in a range covered with the broken lines B1 to B4. In FIG. 3A, further, R6 represents a decomposing region (which is estimated).

In FIG. 3B, B8 indicates a melanin resulting point; B9 a cyanuric-acid resulting point; BIO a biuret resulting point; and B11 urea resulting point (in mp.). In FIG. 3B, a urea side-reaction product occurs in a range covered with the broken lines B8 to B11.

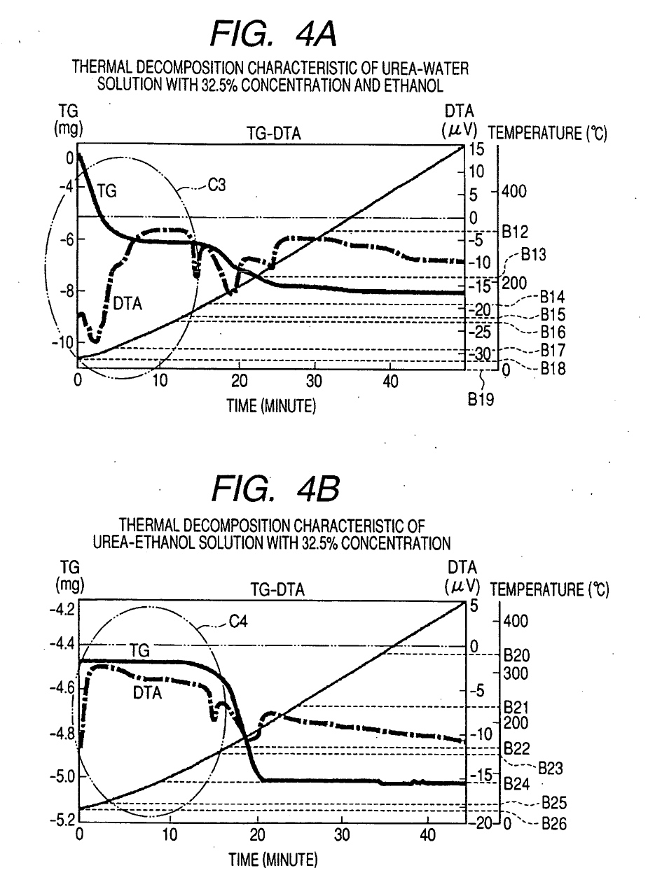

FIG. 4A shows a result of the urea solution, implementing the present invention, in the presence of water and ethanol. A thermal decomposition characteristic (TG-DTA) of a urea-ethanol solution (with the urea concentration of 32.5 wt %) with ethanol being used as a solvent was measured and a measured result is shown in FIG. 4A. FIG. 4B shows a measured result of a thermal decomposition characteristic (TG-DTA) of a urea-ethanol solution in the presence of only ethanol.

In FIG. 4A, B12 indicates a melanin resulting point; B13 a cyanuric-acid resulting point; B14 an ethyl carbamate point; B15 a biuret resulting point; B16 a urea resulting point (in mp.); B17 an ethanol point (in bp.); B18 an ethyl carbamate resulting point; and B19 an ammonia and cyanic acid resulting point caused by the esterification reaction.

As shown in FIG. 4A, a urea side-reaction product occurs in a range covered with the broken lines B12 to B16.

In FIG. 4B, B20 indicates a melanin resulting point; B21 a cyanuric-acid resulting point; B22 a biuret resulting point; B23 a urea resulting point (in mp.); B24 an ethanol point (in bp.); B25 a cyanic acid ammonium resulting point; and B26 an ammonia and cyanic acid resulting point.

As shown in FIG. 4A, a urea side-reaction product occurs in a range covered with the broken lines B20 to B23.

As will be apparent from a TG curve shown in FIG. 3A, it is estimated that a decomposition reaction of urea water occurred in a reacting region (indicated by an encircled phantom line) C1 to generate ammonia gas at a temperature less than a boiling point 104° C. of the urea-water solution. A peak (at 71° C.), appearing on a DTA curve in the reaction region C1, is not detected on the DTA curve of urea powder in a region C2 shown in FIG. 3B (see an arrow A1) and almost no variation occurs on this TG curve. Thus, it is turned out that the existence of water is essential for ammonia gas to be generated in the thermal decomposition. This decomposition reaction has an upper limit temperature of approximately 85° C. Like urea powder, if the upper limit temperature of the decomposition reaction exceeds the boiling point of 104° C., a reaction product is created due to undecomposed urea water.

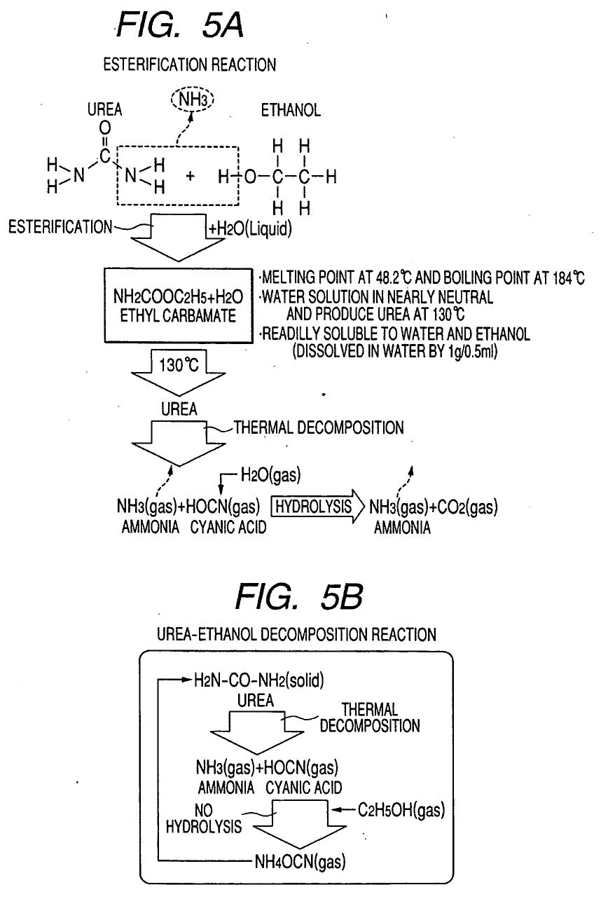

As shown in FIG. 4A, on the contrary, in a case where water and ethanol are both used, a rapid drop occurs on the TG curve at a lower temperature side in a reacting region (encircled in a phantom line) C3 at a temperature less than the boiling point (of 104° C.) of the urea-water solution. Thus, it is apparent that the DTA curve has a peak (at 35° C.) at a point shifted to a lower temperature side. This is because it is estimated that an esterification reaction occurs in the antifreezing urea solution of the present invention containing water and ethanol in coexistent with each other to generate ammonia as shown in FIG. 5A. Ethyl carbamate (NH₂COOC₂H₅), generated upon esterification reaction, is readily soluble to water and ethanol. A water solution generates urea at 130° C. and subjected to thermal decomposition and hydrolysis, thereby generating ammonia.

As shown in FIG. 4B, however, like the result of urea powder, a urea-ethanol solution containing only ethanol as a solvent had almost no variation on the TG curve in an area up to a melting point (132° C.) of urea in a reacting region C4 and no peak, accompanied by ammonia gas generation due to thermal decomposition of urea, was present. In this case, the decomposition reaction of urea-ethanol progressed and resulting cyanic acid was present in the presence of ethanol with no hydrolysis taking place. From these results, it will be apparent that not only the organic solution of the alcohol family but also the existence of water are important for the generation of ammonia due to the esterification reaction.

From the foregoing results, it can be understood that the antifreezing urea solution of the present invention is composed of the urea-water solution and the organic solvent of the alcohol family in coexistence with each other. This enables urea to be subjected to the esterification reaction, the thermal decomposition and the hydrolysis, making it possible to generate ammonia at a relatively low temperature with increased efficiency. Also, it becomes possible for the antifreezing urea solution of the present invention to have a remarkably low freezing point in contrast to that of the urea solution of the related art, making it possible to obtain an antifreezing urea solution with no fear of the freezing occurring even in a cold area. Thus, no need arises for preparing heater means or the like, resulting in the formation of a simplified system structure. In addition, ammonia reducing gas can be supplied to the SCR catalyst in a stable fashion, realizing increased NOx purifying performance.

While the specific example of the present invention has been described above in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof. For instance, the antifreezing urea solution of the present invention is not limited to have an application to the urea SCR system shown in the drawings and may be applied to various other structures known in the art.

What is claimed is:

1. An antifreezing urea solution for use in a urea SCR system having an SCR catalyst disposed in an exhaust passage of an internal combustion engine for selectively reducing NOx, the antifreezing urea solution comprising:
a concentrated urea solution with a urea concentration of 30 wt % or more; and
an organic solvent of an alcohol family with 1 to 7 carbon atoms;
wherein the urea solution and the organic solvent of the alcohol family are mixed to each other to form a mixed solution at a mixture ratio of 7:1 respectively (in a volume ratio) or more.

2. The antifreezing urea solution according to claim 1, wherein:
the mixture ratio of the organic solvent of the alcohol family to the urea solution is 4:1 (in a volume ratio) or more.

3. The antifreezing urea solution according to claim 1, wherein:
the organic solvent of the alcohol family is alcohol with 1 to 3 carbon atoms.

4. The antifreezing urea solution according to claim 1, wherein:
the urea solution has a concentration ranging from 32 to 34 wt %.

5. An antifreezing urea solution for use in a urea SCR system having an SCR catalyst disposed in an exhaust passage of an internal combustion engine for selectively reducing NOx, the antifreezing urea solution comprising:
a mixed solution composed of a urea solution containing urea, serving as an ammonia source, and water which are mixed to each other at a mixing ratio of 1:1 (in a molar ratio) for hydrolyzing urea, and an organic solvent of an alcohol family with 1 to 7 carbon atoms having a hydrophilic group and serving as a freezing point depressant;
wherein the urea solution and the organic solvent of the alcohol family are mixed to each other to form the mixed solution with a freezing point of −30° C. or less.

6. A urea SCR system using the antifreezing urea solution according to claim 1, the urea SCR system comprising:
an antifreezing urea solution tank for accommodating therein the antifreezing urea solution;
urea adding means disposed in an area upstream of the SCR catalyst; and
a urea supply passage through which the urea adding means and the antifreezing urea solution tank are connected to each other.

7. The urea SCR system according to claim 6, wherein:
the urea SCR system has no heating means for heating the solution prevailing in the urea supply passage and the antifreezing urea solution tank.
